(19) United States
(12) Patent Application Publication
(10) Pub. No.: US 2005/0204370 A1
(43) Pub. Date: Sep. 15, 2005

(54) Optical disk apparatus

(75) Inventor: Seiji Hamaie, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 10/901,745

(22) Filed: Jul. 28, 2004

(30) Foreign Application Priority Data
Mar. 11, 2004 (JP) 2004-069231

(51) Int. Cl. G11B 17/03

(52) U.S. Cl. 720/601

(57) ABSTRACT

A technique for assuring reliability in loading and unloading an optical disk into and from an optical disk apparatus is provided. Each of a pair of rail guiding members for guiding a movement of a pair of rail members, on which a tray having a turntable slides, has a rail sliding surface on which the rail member slides; and a distance between the rail sliding surface and an inner surface of the top case increases in a direction of unloading the optical disk.

### BACKGROUND OF THE INVENTION

1. Field of the Invention

The present invention relates to an optical disk apparatus, in particular to a technique of loading and unloading an optical disk.

2. Description of Related Art

As techniques related to this invention, those as disclosed in JP-A-7-254263 and JP-A-7-14277, are known, for instance. In JP-A-7-254263 is disclosed an apparatus where an opening is provided in a top case covering a chassis at a portion to which a turntable on a tray is opposed while the tray with the disk being mounted thereon is inside the chassis, the opening being closed by a cover having a thickness smaller than that of the top case. On the other hand, in JP-A-14277 is disclosed an disk apparatus where a disk tray is guided by a guiding mechanism such that the tray is inclined upwardly from rear to front as the disk tray is ejected from a main body of the apparatus, to prevent the tray from being inclined downwardly from rear to front when ejected.

### SUMMARY OF THE INVENTION

When to reduce a thickness or vertical dimension of the apparatus according to the above-described conventional techniques, a clearance between the top case and internal components and a clearance between the bottom case and the internal components, and a thickness of each of the top case and the bottom, may be decreased. In a case where such reduction in the clearances and thicknesses is made, when the disk is loaded/unloaded into/from the main body of the apparatus while the top case and/or bottom case deflects inward, for instance, protruding part of the tray or the turntable on the tray may contact an inner surface of the top case or others, obstructing movement of the tray. Particularly in a case where the apparatus is arranged such that the top case is pressed from the outside by a spring for grounding or other members and thereby deflects inward, the risk of contact between the inner surface of the top case and the protruding part of the tray or turntable increases.

In view of the above-described situations, a problem to be solved by the present invention is, in an optical disk apparatus, to enable an optical disk to be smoothly loaded and unloaded without a tray or turntable on the tray contacting an inner surface of a top case of the apparatus, even where the top case is pressed by a spring for grounding or other members.

That is, an object of the invention is to provide a technique for assuring reliability in actions of loading/unloading an optical disk in an optical disk apparatus, even where a vertical dimension of the apparatus is reduced.

To attain the above object, the invention provides an optical disk apparatus comprising a turntable disposed on a tray, wherein a rail guiding member for guiding a movement of a rail member on which the tray slides has a rail sliding surface on which the rail member slides, a distance between the rail sliding surface and an inner surface of a top case increasing in a direction of unloading an optical disk.

According to the invention, reliability in the actions of loading and unloading the optical disk can be assured, even where the vertical dimension of the apparatus is reduced.

### BRIEF DESCRIPTION OF THE DRAWINGS

FIG. 1 is a view showing an optical disk apparatus according to a first embodiment of the invention.

FIG. 2 is a side elevational view in enlargement of a rail guiding member and a rail member with their vicinity of the apparatus shown in FIG. 1.

FIG. 3 is a side elevational view of the apparatus where a tray is pulled out from a main body of the apparatus.

FIG. 4 is an external view of the apparatus as seen from the side of a top case of the apparatus.

FIG. 5 is a side elevational view in enlargement of a rail guiding member and a rail member with their vicinity of an optical disk apparatus according to a second embodiment of the invention.

### DETAILED DESCRIPTION OF THE PREFERRED EMBODIMENTS

There will be described the best modes for carrying out the present invention, by reference to the accompanying drawings.

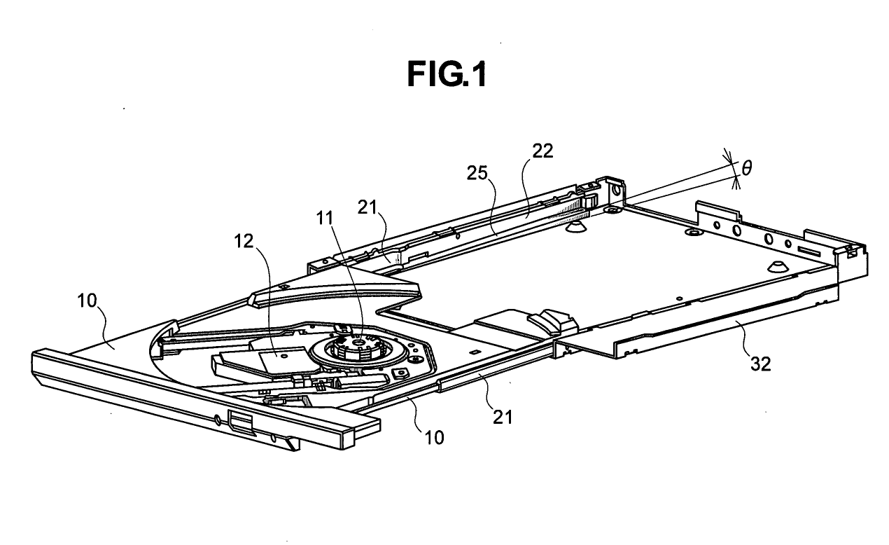

In FIG. 1, reference numeral 10 denotes a tray which is moved with an optical disk being mounted thereon for loading/unloading the optical disk into/from a main body of an optical disk apparatus according to a first embodiment of the invention. Reference numerals 11 and 12 respectively denote a turntable for rotating the optical disk, and an optical pickup for recording/playbacking signals on the optical disk. Reference numeral 21 denotes each of a pair of rail members which engages with one of opposing two sides of the tray 10 from the outside and moves with the tray 10 in a direction of loading or unloading the disk. Reference numeral 22 denotes each of a pair of rail guiding members having a rail sliding surface 25 on which corresponding one of the rail members 21 slides. A distance between the rail sliding surface 25 and an inner surface of a top case (not shown in FIG. 1) covering the apparatus varies with respect to the direction of loading or unloading the disk. Each rail guiding member 22 engages with the one of the rail members 21 on the rail sliding surface 25 to guide the movement of the rail member 21. Reference numeral 32 denotes a bottom case covering the apparatus together with the top case.

In the apparatus shown in FIG. 1, the top case (not shown in FIG. 1) is disposed above the bottom case 32, such that the inner surface of the top case and an inner surface of the bottom case 32 are substantially parallel to each other. The turntable 11 is directly connected to a disk motor (not shown) which drives or rotates the turntable 11, for instance by an arrangement such that the turntable 11 constitutes part of a rotor of the motor. The rail sliding surface 25 in the first embodiment is a linear slant surface which is inclined at an angle θ such that the distance between the rail sliding surface 25 and the inner surface of the top case gradually increases in the direction of unloading the disk. The angle of inclination θ is about 0.2°-0.5°, for instance. The disposition of the rail sliding surface 25 with the inclination such that the distance between the tray 10 or other members on the tray 10 and the inner surface of the top case gradually increases in the direction of unloading the disk, assures preventing the tray 10 and members on the tray 10 such as the turntable from contacting the inner surface of the top case while the disk is being loaded or unloaded.

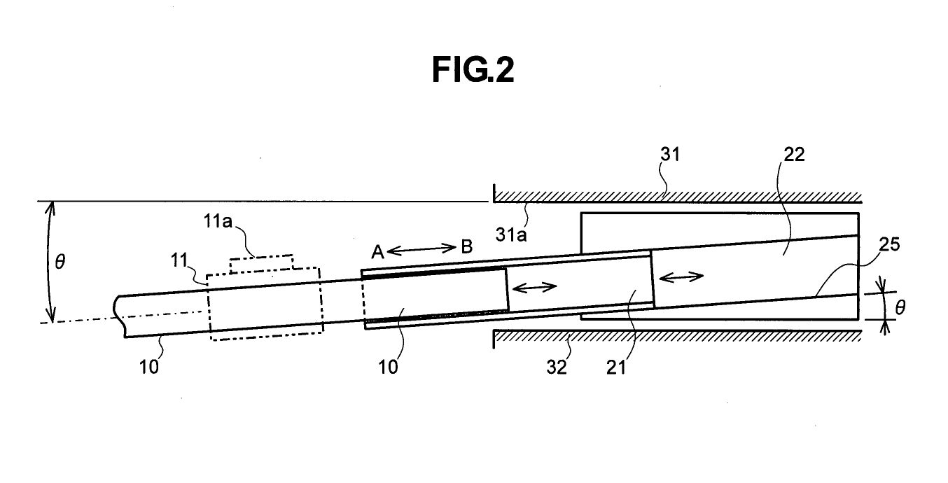

FIG. 2 is a side elevational view in enlargement of the rail guiding member and rail member with their vicinity of the apparatus shown in FIG. 1.

In FIG. 2, reference numeral 11a denotes a protrusion of the turntable 11; reference numeral 31 denotes the top case disposed on the side of the turn table 11 and covering the optical disk apparatus to constitute an exterior surface of the apparatus; reference numeral 31a denotes the inner surface of the top case; and reference numeral 32 denotes the bottom case which is opposed to the top case 31 and covers the optical disk apparatus together with the top case 31 to constitute the exterior surface of the apparatus. Each rail member 21 engages with a side of the tray 10 from the outside such that the tray 10 is movable in sliding contact with the rail members 21, while each rail guiding member 22 engages with one of the rail members 21 from the outside such that the rail member 21 is movable in sliding contact with the rail guiding member 22. The rail sliding surface 25 of each rail guiding member 22 is a linear slant surface inclined at an angle θ, that is, the rail sliding surface 25 is inclined at an angle θ with respect to the bottom case 32 and the inner surface 31a of the top case 31.

When the tray 10 is moved in the direction of unloading the disk (i.e., direction A in FIG. 2), the tray 10 moves in the direction of unloading the disk (direction A) with respect to the rail members 21, while the rail members 21 move with respect to the rail guiding members 22 in the direction of unloading the disk (direction A) on the rail sliding surfaces 25 of the rail guiding members 22 each of which is the linear slant surface inclined at the angle θ. With the tray 10 and rail members 21 moving as described above, the distance between each rail sliding surface 25 and the inner surface 31a of the top case 31 gradually increases the more away from the inner surface 31a in the direction A. At this time, in the case where the most protruding part in a portion of the tray 10 which is inserted into the main body of the apparatus is the protrusion 11a of the turntable 11, for instance, a distance between the protrusion 11a and the inner surface 31a of the top case 31 gradually increases, such that there is secured a distance between each rail sliding surface 25 and the inner surface 31a such that a contact between the protrusion 11a and inner surface 31a is assuredly prevented even while the tray 10 is within a range where at least the protrusion 11a is plenary overlaps the inner surface 31a of the top case 31.

When the tray 10 is moved in a direction of loading the disk (i.e., direction B in FIG. 2), the tray 10 moves with respect to the rail members 21 in the direction of loading the disk (direction B), while the rail members 21 moves on the rail sliding surfaces 25 in the direction of loading the disk (direction B). At this time, with the movements of the tray 10 and rail members 21, the distance between each rail sliding surface 25 and the inner surface 31a of the top case gradually decreases the closer to the inner surface 31a, such that there is secured a distance between each rail sliding surface 25 and the inner surface 31a such that a contact between the protrusion 11a and inner surface 31a is assuredly prevented even while the tray 10 is within a range where at least the protrusion 11a is planarly overlaps the inner surface 31a of the top case 31. While the protrusion 11a is within the range to planarly overlap the inner surface 31a, the distance between the protrusion 11a and inner surface 31a is not smaller than about 0.9×10⁻³ m, for instance. Where the distance of the above-indicated value is established, even where the top case 31 is pressed from the outside by the spring for grounding or other members, the distance between the protrusion 11a and inner surface 31a is assuredly retained, preventing the contact therebetween. In a case where the top case 31 is provided by an aluminum material having a thickness of about 0.6×10⁻³ m, for instance, it is calculated that a deflection of about 0.3×10⁻³ m to 0.5×10⁻³ m takes place at the inner surface of the top case 31 when pressed by the spring for grounding or other members. In this case, the above-described arrangement of the first embodiment can easily assure the distance of the above-indicated value between the protrusion 11a and the inner surface 31a of the top case 31. To assure the appropriate distance between the most protruding part of the tray 10 and the inner surface 31a of the top case 31 even where the top case 31 is deflected, it is desirable that each rail sliding surface is inclined at an angle of about 0.2°-0.3°.

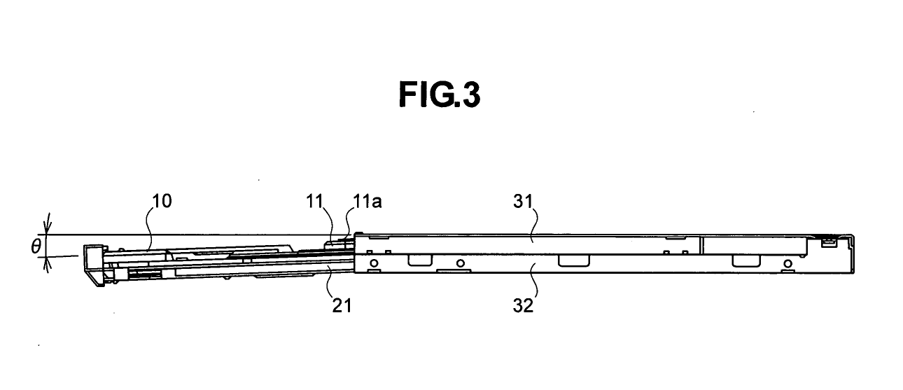

FIG. 3 is a side elevational view of the optical disk apparatus of FIG. 1 in a state where the tray 10 is halfway pulled out from the main body of the apparatus. The tray 10 is pulled out in a direction inclined at an angle θ with respect to the inner surface (not shown in FIG. 3) of the top case 31 of the main body. Thus, even where the protrusion 11a of the turntable 11 protrudes from the turn table 11, the protrusion 11a does not contact the inner surface of the top case 31. When the tray 10 is inserted into the main body of the apparatus for loading the disk, the tray 10 is inserted in a direction inclined at the angle θ with respect to the inner surface of the top case 31 of the main body. Hence, the protrusion 11a does not contact the inner surface of the top case 31.

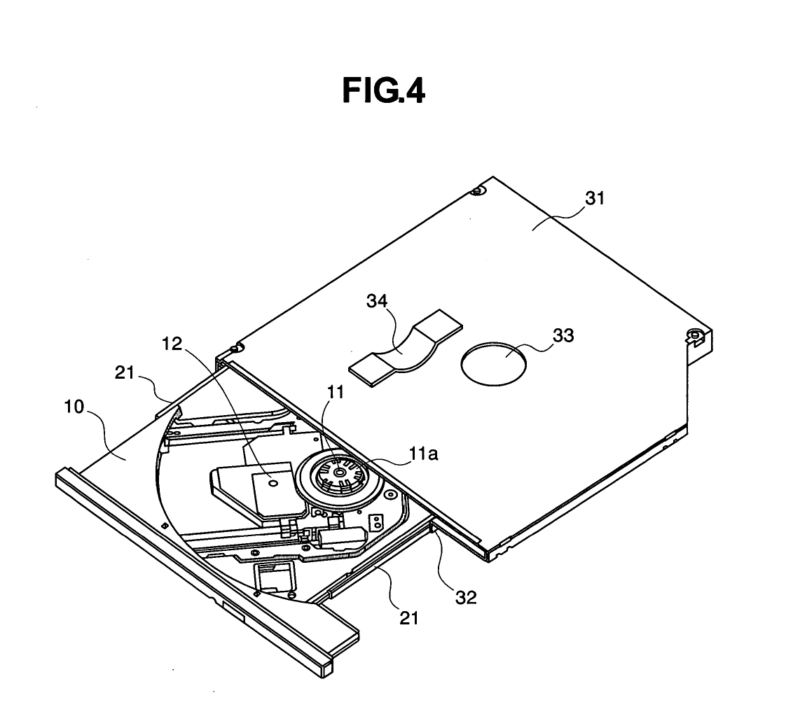

FIG. 4 is an external view of the optical disk apparatus of FIG. 1 as seen from the side of the top case 31.

In FIG. 4, reference numeral 33 denotes an opening formed in the top case 31 for avoiding contact between the protrusion 11a of the turntable 11 and the inner surface of the top case 31 while the tray 10 is completely inserted in the main body of the apparatus, and reference numeral 34 denotes a spring for grounding. The opening 33 is formed in a top face of the top case 31a in a circular shape, such that the opening 31 is concentric with the turntable 11 while the tray 10 is located at a position where the tray 10 is positioned when completely inserted in the main body. A diameter of the opening is larger than an outer diameter of the protrusion 11a. The spring 34 for grounding presses the outer surface of the top case 31 by its resilient restoring force, for grounding purpose. When the disk is loaded, the tray 10 is moved from a position where the turntable 11 is located outside the main body of the apparatus, that is, outside a space defined between the top case 31 and bottom case 32, to another position where the center of the turntable 11 substantially aligns with that of the opening 33 of the top case 31, i.e., completely inserted position. On the other hand, when the disk is unloaded, the tray 10 is moved from the completely inserted position where the turntable 11 and the opening 33 are substantially concentric, to the position outside the main body. During both of the disk loading and unloading actions, the protrusion 11a of the turntable 11 does not contact the inner surface of the top case 31 by the arrangements as described with regard to FIGS. 1-3.

According to the first embodiment of the invention as described above, the optical disk apparatus is configured such that even where the top case is pressed by the spring for grounding or other members, the protruding part of the tray such as the turntable does not contact the inner surface of the top case, enabling the optical disk to be smoothly loaded and unloaded.

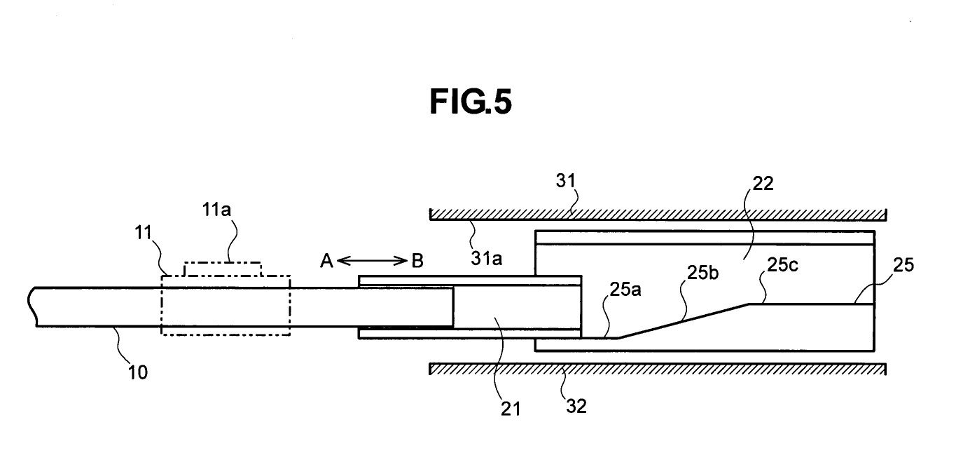

FIG. 5 is an explanatory view of an optical disk apparatus according to a second embodiment of the invention, showing in enlargement a rail guiding member 22. In the second embodiment, the rail sliding surface 25 of the rail guiding member 22 is stepped.

In FIG. 5, reference numerals 25a, 25b and 25c respectively denote a first sliding surface, a second sliding surface, and a third sliding surface. Each of a pair of rail members 21 engages with one of opposing two sides of a tray 10 from the outside such that the tray 10 is movable in sliding contact with the rail members 21, while a pair of rail guiding members 21 engages with one of the rail members 21 from the outside such that each of the rail members 21 is movable in sliding contact with corresponding one of the rail guiding members 22. Each of the first, second and third sliding surfaces 25a-25c is a linear planar surface. The first and third sliding surfaces 25a, 25c are substantially parallel to each other, while the second sliding surface 25b is inclined with respect to the first and third sliding surfaces 25a, 25c and connects these surfaces 25a, 25c. A difference between heights of the first and third sliding surfaces 25a, 25c is about 0.3×10⁻³-0.5×10⁻³ m.

When the disk is unloaded, the tray 10 is moved with respect to the rail members 21 in a direction of unloading the disk (direction A), while each of the rail members 21 moves with respect to the corresponding rail guiding member 22 in the direction of unloading the disk (direction A) on the rail sliding surface 25, more specifically, sequentially on the third sliding surface 25c, second sliding surface 25b and first sliding surface 25a in the order of description. With the movements of the tray 10 and the rail members 21, a distance between the rail sliding surface 25 and an inner surface 31a of the top case 31 is the smallest at the third sliding surface 25c, gradually increases the more advanced in the direction A at the second sliding surface 25b, and is the largest at the first sliding surface 25a. Where the most protruding part of a portion of the tray which is inserted into a main body of the apparatus is a protrusion 11a of the turntable 11, for instance, a distance between the protrusion 11a and the inner surface 31a of the top case 31 is the smallest at the third sliding surface 25c, gradually increases the more advanced in the direction A at the second sliding surface 25b, and is the largest at the first sliding surface 25a. According to this arrangement, there is secured a distance between the rail sliding surface 25 and the inner surface 31a for assuredly preventing a contact between the protrusion 11a and the inner surface 31a even while the tray 10 is within a range where at least the protrusion 11a is planarly overlaps the inner surface 31a of the top case 31.

When the tray 10 is moved in a direction of loading the disk (direction B), the tray 10 moves with respect to the rail members 21 in the direction of loading the disk (direction B), while each of the rail members 21 moves with respect to the corresponding rail guiding member 22 in the direction of loading the disk (direction B) on the rail sliding surface 25, more specifically, sequentially on the first sliding surface 25a, second sliding surface 25b and third sliding surface 25c in the order of description. At this time, a distance between the rail sliding surface 25 and an inner surface 31a of the top case 31 is the largest at the first sliding surface 25a, gradually decreases the more advanced in the direction B at the second sliding surface 25b, and is the smallest at the third sliding surface 25c. There is secured a distance between the rail sliding surface 25 and the inner surface 31a for assuredly preventing a contact between the protrusion 11a and the inner surface 31a even while the tray 10 is within a range where at least the protrusion 11a is planarly overlaps the inner surface 31a of the top case 31. While the protrusion 11a is within the range to planarly overlap the inner surface 31a of the top case 31, the distance between the protrusion 11a and inner surface 31a is not smaller than about 0.9×10⁻³ m, for instance. Where the distance of the above-indicated value is established, even where the top case 31 is pressed from the outside by the spring for grounding or other members, the distance between the protrusion 11a and inner surface 31a is assuredly retained, preventing the contact therebetween.

According to the second embodiment of the invention as described above, the optical disk apparatus is configured such that even where the top case is pressed by the spring for grounding or other members, the protruding part of the tray such as the turntable does not contact the inner surface of the top case, enabling the optical disk to be smoothly loaded and unloaded, like the apparatus according to the first embodiment.

Although in the second embodiment the rail sliding surface of the rail guiding member comprises a linear slant surface and a plurality of linear planar surfaces connected via the linear slant surface, configuration of the rail sliding surface is not limited to this; for instance, the rail sliding surface may be a curved surface, a plurality of curved surfaces as connected, or a curved surface and a linear planar surface which are connected.

1. An optical disk apparatus which loads an optical disk into the apparatus by means of a tray and rotates the optical disk by a turntable to record and/or playback data on the optical disk, the apparatus comprising:
the tray having the turntable;
a top case which is disposed on the side of the turntable and covers the apparatus;
a pair of rail members each of which engages with one of opposing two sides of the tray such that the tray is movable in sliding contact with the rail members, and moves with the tray in a direction of loading or unloading the optical disk;
a pair of rail guiding members, each of which has a rail sliding surface a distance between which and an inner surface of the top case increases in a direction of unloading the optical disk, and engages with one of the rail members on the rail sliding surface to guide the movement of the rail member.

2. The apparatus according to claim 1, wherein the rail sliding surface of each of the rail guiding members is a linear slant surface.

3. The apparatus according to claim 1, wherein the rail sliding surface of each of the rail guiding members comprises a plurality of linear planar surfaces disposed in a stepped fashion.

4. The apparatus according to claim 3, wherein each adjacent two of the plurality of linear planar surfaces are connected via a slant surface.

5. The apparatus according to claim 1, wherein the rail sliding surface of each of the rail guiding members is configured so that the turntable does not contact the top case.

6. The apparatus according to claim 1, wherein the rail sliding surface of each of the rail guiding members is inclined at an angle of about 0.2°-0.3° with respect to a surface of the top case.
